(19) United States
(12) Patent Application Publication
(10) Pub. No.: US 2007/0250524 A1
(43) Pub. Date: Oct. 25, 2007

(54) METHOD AND APPARATUS FOR WORKLOAD AND MODEL BASED MATERIALIZED QUERY TABLE OR VIEW RECOMMENDATION TECHNIQUE

(76) Inventor: Jian Le, San Mateo, CA (US)

Correspondence Address: DUKE W. YEE, P.O. BOX 802333, YEE & ASSOCIATES, P.C., DALLAS, TX, 75380, US

(21) Appl. No.: 11/379,372

(22) Filed: Apr. 19, 2006

(51) Int. Cl. G06F 7/00

(52) U.S. Cl. 707/102

(57) ABSTRACT

A computer implemented method for generating data for a database. A plurality of slices are identified within the database. The plurality of slices are described using metadata for the database. A set of slices are selected from the plurality of slices based a policy to form a selected set of slices. A recommendation to materialize the selected set of slices is generated.

### BACKGROUND OF THE INVENTION

1. Field of the Invention

The present invention relates generally to an improved data processing system and in particular to a method and apparatus for managing a database. Still more particularly, the present invention relates to a computer implemented method, apparatus, and computer usable program product for constructing, consolidating, and recommending materialized query tables.

2. Description of the Related Art

A database is a systematic organization of data, organized for efficient and reliable storage, retrieval, and processing. A database may contain large volumes of information organized in complex organizations called tables, such tables having rows of correlated data. The accessing and manipulation of data is performed using queries.

As data is collected over time, the collected data becomes important for trending and forecasting, facilitating decision-making in organizations with such data. A data warehouse is a type of database that is specifically designed towards storing data collected over time from various sources, including other databases, and providing analytical capabilities for use with the stored data. Data warehouses are typically designed to favor efficient data analysis and reporting. More specifically, tables of a data warehouse are often designed in such way that rapidly changing information such as measures are stored in one or more center tables and static or slowly changing information such as dimension attributes are stored in one or more look-up tables that join the center tables on a set of surrogate keys. Furthermore, dimension attributes stored in one or more look-up tables are often subcategorized such that a hierarchical relationship exists among subsets of dimension attributes. Two popular data warehouse schema are presently used. One is a star schema that has one or more fact tables at the center and one or more dimension tables joined to the fact table. The other is a snowflake schema that is an extension of a star schema such that one or more dimensions are defined by multiple tables.

One common usage of data warehouse data for analysis and reporting is to derive aggregated data from stored data in various aspects and facets of a subject matter. For example, if one wants to analyze the sales activities (a subject matter) of stores (one aspect) over time (another aspect), one can use the sales data collected at each store over each day (base data) to compute the total sales (measure) of each store over each month, or the total sales (measure) of each store over each quarter, or the total sales (measure) of each store over each year. Here in this example, day, month, quarter, and year represent four different facets of the Time aspect. Similarly, one can use the sales data at each store over each day (base data) to compute the total sales of each district over each day, or the total sales of each division over each day, or the total sales of each division over each month. Here, store, district, and division represent three different facets of the Store aspect. Therefore, any combination of a facet from each participating aspect of a subject matter forms a possible flavor of aggregated data of this subject matter except the combination of store and day facets as they represent the base data of this subject matter.

To facilitate efficient data analysis and reporting, plausible subject matters of a data warehouse and their related aspects, and facets are often specified using metadata objects during the logical-design phase of a data warehouse project and are commonly stored inside a metadata repository. A subject matter is usually specified by a Cube Model metadata object that references a set of Dimension metadata objects with each one of them specifying an aspect of this subject matter. Then each Dimension metadata object can have one or more Hierarchy metadata objects. Also, each Hierarchy metadata object contains an ordered list of Level metadata objects with each one of them specifying a facet of an aspect. FIG. 3B demonstrates a sample Cube Model object that references three Dimension objects: Product, Store, and Time, and one sample Facts object that contains seven sample Measure objects. FIG. 3C shows a sample Dimension object that contains a sample Hierarchy object, which, in turn, references three sample Level objects.

FIG. 4A shows that the Product dimension has one hierarchy, the Store dimension has one hierarchy, and the Time dimension has two hierarchies. Then, after a data warehouse is created, the metadata objects of this data warehouse stored in a repository effectively describe the relevant subject matters, aspects, facets and the relationships among these elements. More specifically, the dimension objects, the hierarchy objects, the levels objects, and the measure objects associated with a cube model object clearly describe the base data and many flavors of aggregate data of a subject matter represented by this cube model object. Since the base data and aggregate data of a subject matter are usually stored in a subset of tables of a data warehouse, this collection of base data, aggregate data, and tables that store this data are referred to as a data warehouse schema or a star schema. For simplicity, we also refer to a flavor of aggregate data defined by a combination of a facet (or a level) from each participating aspect (or a hierarchy) of a subject matter (or a cube model) as an aggregation slice or a slice of this data warehouse schema. FIG. 4A shows about 600 possible aggregation slices of a sample data warehouse schema.

As can be seen from FIG. 4A, a data warehouse schema can have many possible groupings of aggregates. For instance, one possible grouping of aggregates involves aggregate data at the Line, State, All Time, and Month levels. To speed up applications that derive multiple complex measures from simple aggregates of a data warehouse, one has chosen to materialize these simple aggregates. For example, the monthly sales data aggregated from the daily sales data can be used to compute the percentage of a monthly sales data with respect to a yearly sales data, or the same monthly sales data can be used to compute the monthly sales growth rate over two consecutive months, or the same monthly sales data can be used to compute the monthly sales gains over a quarter.

To that end, simple aggregates of a data warehouse schema could be pre-materialized so that simple aggregates could be shared by multiple complex measure calculations. Furthermore, as a data warehouse increased in size, not pre-materializing simple aggregates often resulted in increased database resource expenditures from repeated computation of identical simple aggregates from the same base data. To assuage this problem, materialized query table (MQT) technology was developed.

A materialized query table (MQT) stores the definition of a structured query language (SQL) query and the result set of this SQL query. As such, a materialized query table typically contains pre-computed results based on the data existing in a table or tables on which its definition query is based. For example, when a materialized query table stores an aggregation query that summarizes daily sales data into monthly sales data and the results of this query, namely the summarized monthly sales data, a database engine can use the stored query definition information and stored query results to answer a separate query that requires the summarization of the same set of daily sales data, for example, into quarterly sales data. In this example, the database engine can use the data records from the monthly sales MQT table to compute the quarterly sales value rather than using the numerous daily sales records from the base data. Thus, using the stored query definition information and results to process a different query request decreases the database engine workload.

A materialized query table (MQT) is commonly used by the users of a DB2 relational database, while a materialized view (MV), similar technology to MQT, may be used for other relational databases.

A system may recommend MQT tables using workload information. Present techniques for recommending materialized query tables using query workload information use column information referenced by individual queries of a query workload to construct, consolidate, and recommend candidate materialized query tables. Recommended materialized query tables, however, are often seen to be effective to reroute queries present in the current query workload and less effective to reroute queries that are similar to these queries but have different columns or expressions. In addition, consolidation of candidate materialized query tables during the recommendation process is difficult. This is because when column information is used to construct candidate materialized query tables, many candidates may need to be evaluated before a consolidated set of candidate materialized query tables are identified. For example, if a query workload has m unique group-by columns and n unique measure columns over all queries of a given query workload, 2**(m+n) possible candidate materialized query tables may need to be evaluated. Thus, as the number of different group-by columns and measure columns increases, the amount of resources and time needed to evaluate the candidate materialized query table set increases exponentially.

Furthermore, a candidate MQT defined by an arbitrary combination of columns and measures of a query workload may not be appropriate if they come from different data warehouse schemas.

Moreover, the materialized query tables or materialized views recommended may differ from one query workload to another because the structures of candidate materialized query tables change in accordance with the characteristics of queries contained within a specific query workload. As a result, the database engine must expend resources to maintain MQTs or MVs

Another way to construct, consolidate, and recommend candidate materialized query tables is to use common query graph models. Common query graph models, however, may re-route queries in the same data warehouse sub-regions differently when these queries have different query graph models or different expressions. In addition, accumulating query graph models and sub-models to construct common query graph models requires a sizable expenditure of database engine resources. Furthermore, the database engine must expend resources to maintain the MQTs or MVs because the common query graph models or common expressions are query workload specific.

Therefore, it would be advantageous to have an improved computer implemented method, apparatus, and computer usable program product for constructing, consolidating, and recommending materialized query tables for databases, such as a data warehouse.

### SUMMARY OF THE INVENTION

The present invention provides a computer implemented method, apparatus, and computer usable program code for generating data for a database. A plurality of logical sets of aggregation data within a database is identified. The plurality of logical sets of aggregation data are described by metadata for the database. A number of logical sets of aggregation data is selected from the plurality of logical sets of aggregation data based on a policy to form a selected number of logical sets of aggregation data. A materialization of the aggregation data is recommended using the selected number of logical sets of aggregation data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server or a client;

FIG. 3A is a block diagram of a data warehouse in accordance with an illustrative embodiment of the present invention;

FIG. 3B is a diagram of a sample data warehouse schema in accordance with an illustrative embodiments of the present invention;

FIG. 3C is a diagram illustrating a dimension, hierarchy, and levels in accordance with an illustrative embodiment of the present invention;

FIG. 4A is a diagram illustrating four hierarchies of a sample data warehouse schema;

FIG. 4B is a diagram showing four slices constructed from four hierarchies shown in FIG. 4A in accordance with an illustrative embodiment of the present invention;

FIG. 4C is a diagram of an alternate representation of slices shown in FIG. 4B in accordance with an illustrative embodiment of the present invention;

FIG. 5A is a diagram of a query in accordance with an illustrative embodiment of the present invention;

FIG. 5B is a diagram of slices in accordance with an illustrative embodiment of the present invention;

FIG. 6 is a diagram of a query issued against the sample data warehouse schema shown in FIG. 3B in accordance with an illustrative embodiment of the present invention;

FIG. 7 is a diagram of aggregation sub-queries of different forms in accordance with an illustrative embodiment of the present invention;

FIGS. 8A-8C are flowcharts of a process for constructing, consolidating, and recommending materialized query tables from metadata and a given query workload in accordance with an illustrative embodiment of the present invention; and

FIG. 9 is a diagram illustrating a simplified metadata model where multiple hierarchies and levels of a dimension are compressed into a single hierarchy that has two levels for each dimension in accordance with an illustrative embodiment of the present invention.

### DETAILED DESCRIPTION OF THE PREFERRED EMBODIMENT

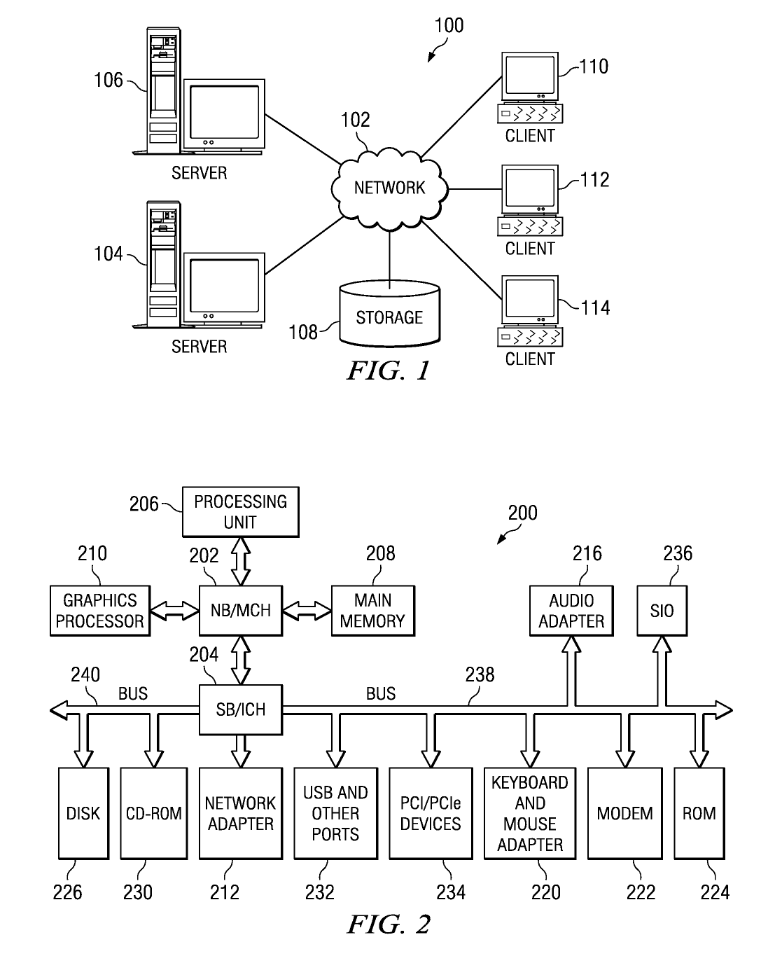

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Specifically, server 104 may function as a database server and provide response to queries and requests for data. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, or a client, such as server 104 or client 108 in FIG. 1, is depicted in accordance with a preferred embodiment of the present invention. As a server, data processing system 200 may host and manage a database, such as a data warehouse. Depending on the implementation a grouping of servers, such as data processing system 200, may be used to implement a data warehouse. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

The illustrative embodiments provide a computer implemented method, apparatus, and computer usable program code for recommending materialized query tables. First, the multi-dimensional metadata for one or more multiple data warehouse schemas is obtained. Secondly, each data warehouse schema is logically divided into a set of disjoint aggregation slices using its multi-dimensional metadata such as cube models, dimensions, hierarchies, levels, facts, measures, attributes, expressions, filters, tables, and table joins. Thirdly, each aggregation sub-query of queries of a given query workload is identified and mapped to an individual aggregation slice of a data warehouse schema. During this identification and mapping process, if an individual slice is traversed by multiple aggregation sub-queries of a given query workload, the hit count of this individual slice is adjusted accordingly. Also during this process, if an individual slice is traversed by an aggregation sub-query that involves one or more non-additive measures, a special flag is assigned to this individual slice. Fourthly, the identified individual slices form an initial set of candidate slices for each data warehouse schema.

As can be seen, candidate slices of present invention are not constructed from columns of queries of a given query workload. Rather, these slices are constructed from the multi-dimensional metadata of a particular data warehouse schema and they cover specific sub-regions of this data warehouse schema. Therefore, when a candidate materialized query table corresponding to a specific candidate slice of a data warehouse schema is materialized in a database, this materialized query table will not only reroute queries of the given query workload that hit this slice, it will also reroute other queries that traverse this slice but are not included in this given query workload. In addition, since a candidate slice constructed by this invention must belong to a specific data warehouse schema, the embodiments of the present invention will never consider a candidate materialized query table that might straddle over multiple data warehouse schemas.

Then, after the initial set of candidate slices are identified for a specific data warehouse schema, the candidate slices are consolidated through a four step process. In step one, the materialized slices of this data warehouse schema in the database are added to the initial candidate slice set. The hit count of these materialized slices is set to 1. In step two, identical slices in the initial candidate slice set are merged and the hit count of the merged slice is set to the sum of the hit count of each individual slice participating in the merge.

In step three, candidate slices at higher levels are merged into candidate slices at lower levels if the corresponding candidate materialized query table of slices at lower levels can reroute the definition query of a candidate materialized query table of a slice at a higher level. If the merge does take place, the hit counts of higher level slices are added to the hit counts of lower level slices. In step four, two candidate slices whose mutual distance is less than a user-configurable threshold value are merged into a new candidate slice if the definition query of the new slice can reroute the definition queries of these two candidate slices participating the merge. If the merge does take place, the hit count of the new slice is the sum of the hit counts of these two participating candidate slices. This consolidation process will repeat itself from step three to step four until the total number of candidate slices in the set is less than a user-configurable threshold value or the total table size of candidate slices in the set is less than a user-configurable threshold value, or no candidate slices are merged in the previous iteration cycle.

As can be seen, candidate slices of present invention are not consolidated through an exhaustive combination of candidate slices. Actually, the embodiments of the present invention do not require any combinations at all since the candidate slices of a data warehouse schema are already disjoint. The cardinality of the initial candidate slice set associated with a specific data warehouse schema is never larger than the total number of aggregation sub-queries of the given query workload that traverse this data warehouse schema. In practice, this cardinality number is much smaller than the total number of aggregation sub-queries of the given query workload that hit this data warehouse schema since many aggregation sub-queries are issued against several key individual slices.

Finally, with the different embodiments of the present invention, the candidate materialized query table of a candidate slice at a lower level can reroute queries that visit the slices above itself. This property is intrinsic by the way the slices of a data warehouse schema are designed. For example, a materialized query table defined on a monthly summary slice can be used to reroute queries that traverse the quarterly summary slice and yearly summary slice. Therefore, this intrinsic multi-slice query coverage property of materialized query tables designed using multi-dimensional metadata information allows for further consolidation of candidate slices.

After the candidate slices are consolidated, the final candidate set is decomposed into two subsets, S1 and S2, such that subset S1 corresponds to new slices that need to be materialized in a database and subset S2 corresponds to materialized slices in the database one would like to retain. Then dropping the existing materialized query tables in the database whose slice representation does not belong to subset S2 is recommended. After that, materializing candidate slices in subset S1 is recommended in a descending order of slice hit counts within the limit of computer disk spaces. In the illustrative examples, a slice is materialized when a materialized query table is generated in a database for the slice. A query workload is a set of queries issued by one or more users to the data warehouse.

In the illustrative example, hits are based on queries issued against the data warehouse over some period of time. A set of one or more slices that, for example, accounts for most of the queries, can be selected. The set of selected slices may be compared to the slices that previously existed in the database to determine whether any of these slices may be discarded.

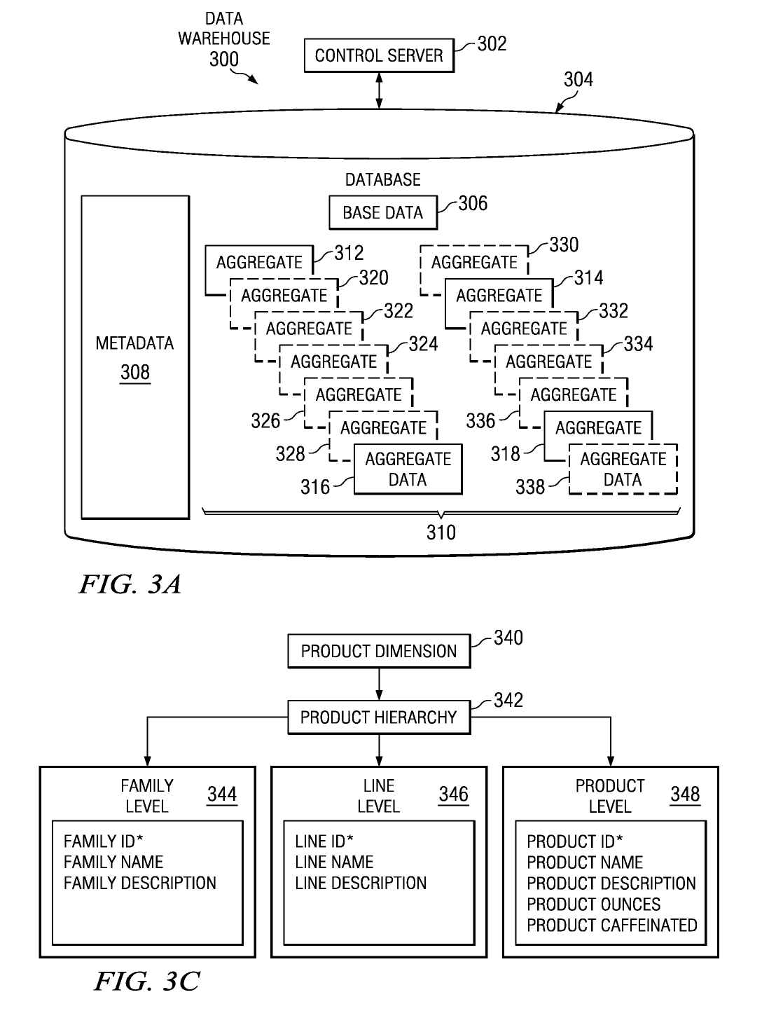

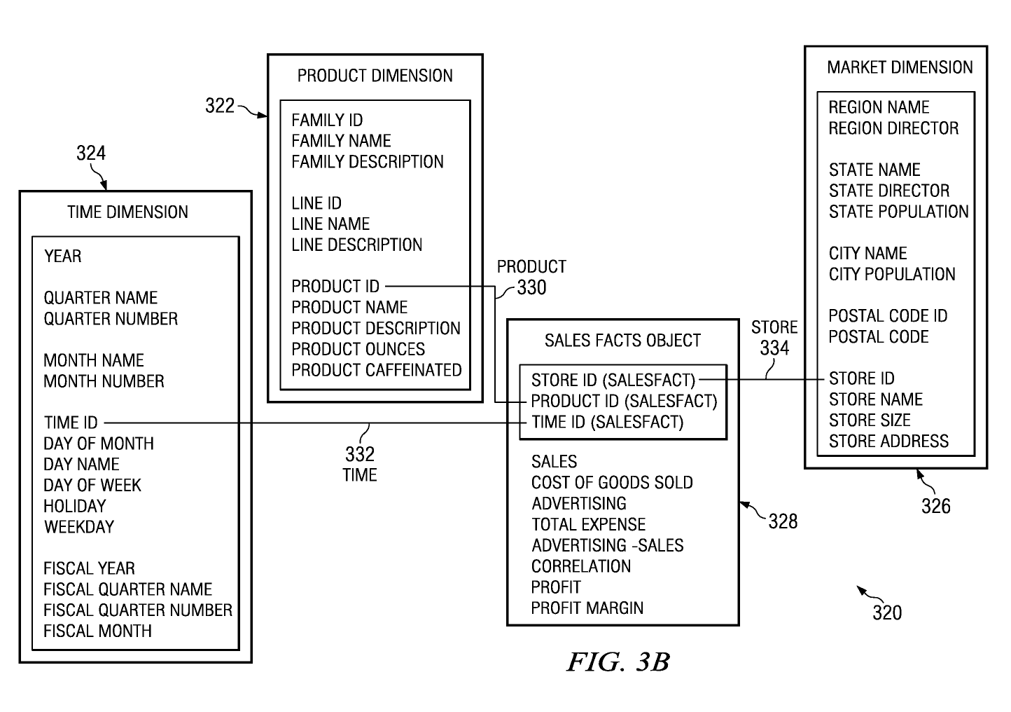

Turning next to FIG. 3A, a block diagram of a data warehouse is depicted in accordance with an illustrative embodiment of the present invention. In this illustrative example, data warehouse 300 includes control server 302 and database 304.

Database 304 includes base data 306, metadata 308, and aggregate data 310. This data may take different forms depending on the particular implementation. Data warehouse 300 may contain other components not shown depending on the particular implementation. Control server 302 is a process that executes on a data processing system, such as data processing system 200 in FIG. 2.

In this illustrative example, control server 302 includes the processes of the present invention used to recommend new aggregation slices for materialization and existing aggregation slices for deletion along with other processes to manage data in database 304. In these examples, aggregation slices are materialized by generating materialized query tables in a database, such as aggregate data 310.

Base data 306 is derived from a set of one or more sources. The data may take many forms, such as historical and/or near real-time data. The set of sources for base data 306 may be a set of databases. For example, base data 306 may contain sales data from databases located at different stores.

Metadata 308 is data used to describe base data 306, aggregate data 310, and the relationships between base data 306 and aggregate data 310, and among aggregate data (e.g., 312, 314, 316 and 318). In this example, metadata 308 contains a set of metadata objects such as cube models, dimensions, hierarchies, levels, facts, measures, filters, tables, and table joins.

In one example, metadata 308 catalogs the aggregate regions within data warehouse 300. Aggregate data 310 includes logical aggregate data and materialized aggregate data. Materialized aggregate data 312, 314, 316, and 318 are represented by boxes with solid lines, and are often referred to as materialized aggregation slices. Logical aggregate data 320, 322, 324, 326, 328, 330, 332, 334, 336, and 338 are represented by boxes with dotted lines and are often referred to as logical aggregation slices. The materialized aggregate data have materialized query tables associated with them. The logical aggregate data are described by metadata 308 but otherwise do not reside in the database.

In a process of recommending materialized query tables, control server 302 may keep track of the number of hits for each of the identified slices using metadata 308. These hits are based on queries made to data warehouse 300. A set of logical aggregation slices is selected from those identified slices. These logical aggregation slices may be combined with materialized aggregation slices for consolidation and final recommendation. In the case of existing materialized aggregation slices, no new materialized query tables need to be generated because they are already present in data warehouse 300. New materialized query tables are recommended for logical aggregation slices in a final set.

The process of recommending new materialized query tables may be activated based on a policy. For example, the policy may specify that these tables are recommended periodically or in response to some change in base data 306.

The materialized aggregate data also may be associated with materialized views and/or user-managed tables containing aggregate values in addition to or in place of the materialized query tables.

Turning to FIG. 3B, a diagram of a sample data warehouse schema is depicted in accordance with an illustrative embodiment of the present invention. In this example, data warehouse schema 320 is a star schema but other data warehouse schemas may be used. Data warehouse schema 320 contains product dimension 322, time dimension 324, and market dimension 326. These dimensions are tied to facts located within sales fact object 328. The ties to sales fact object 328 are referred to as a “joins” in these examples.

As can be seen, the joins are product 330, time 332, and store 334. Columns of data from the relational tables are represented by attribute objects referenced by the dimension as shown in products dimension 322, time dimension 324, and market dimension 326.

With reference now to FIG. 3C, a diagram illustrating a dimension, a hierarchy, and levels are depicted in accordance with an illustrative embodiment of the present invention. Each dimension may have one or more hierarchies with levels that group related attributes. A hierarchy provides a way to calculate and navigate across a dimension.

In this example, Product dimension 340 includes Product hierarchy 342. Product hierarchy 342 stores information about the structure and relationships between attributes grouped within levels.

In this example, the attributes in Product dimension 340 are grouped into three levels. Family level 344 is the top level of Product hierarchy 342. Family level 344 includes Family ID as the level key attribute, Family name as the default attribute, and Family description as the related attribute. The second level, Line level 346, includes Line ID as the level key attribute, Line name as the default attribute, and Line description as the related attribute. The bottom level, Product level 348, includes Product ID as the level key attribute, Product name as the default attribute, and Product description, Product ounces, and Product caffeinated as related attributes.

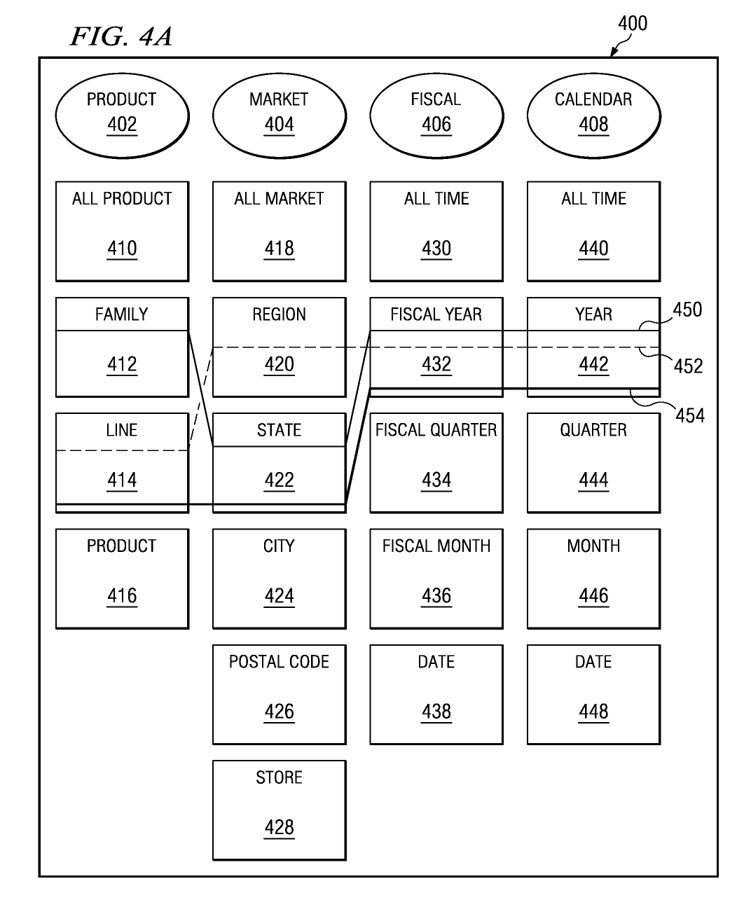

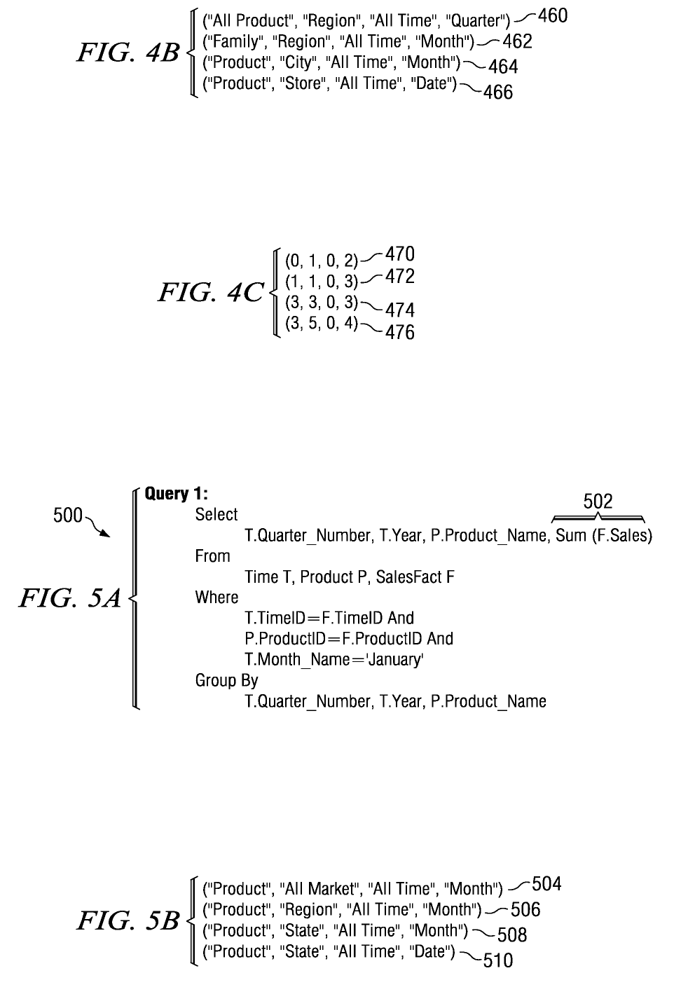

FIG. 4A depicts the four hierarchies of the sample star schema 320 shown in FIG. 3B.

The metadata for star schema 320 in FIG. 3B includes four hierarchies for the three dimensions, (Product, Market and Time): Product 402, Market 404, Fiscal 406, and Calendar 408. These hierarchies are identified using metadata of a data warehouse schema. Each of these hierarchies has various levels of data. For instance, Product 402 contains the following levels: all product 410, family 412, line 414, and product 416. Market 404 contains all market 418, region 420, state 422, city 424, postal code 426, and store 428. Fiscal 406 contains all time 430, fiscal year 432, fiscal quarter 434, fiscal month 436, and date 438. Calendar 408 contains all time 440, year 442, quarter 444, month 446, and date 448. The levels within each hierarchy are shown in a descending order while their level depth values are shown in an ascending order. For example, in the hierarchy called product 402, all product 410 is on the highest level, while product 416 is on the lowest level. In contrast, product 410 has a level depth value of 0 while product 416 has a level depth value of 3 in these examples.

In these examples, the lowest levels (or leaf levels) for product 402, market 404, fiscal 406, and calendar 408 hierarchies are product 416, store 428, date 438, and date 448, respectively. When combined, these levels jointly represent base data. Then, any other combinations of levels across the four hierarchies in FIG. 4A represent aggregate data that may have different aggregated data granularities.

Within a hierarchy, data for a particular level can often be derived from data at any level that is below the current level. For example, in the hierarchy Product 402, data at Family 412 level can be derived from data at either line 414 level or product 416 level. Similarly, data at Line 414 level can be derived from data at product 416 level.

Star schema 320 in FIG. 3B may be divided into a base data slice and a collection of logical aggregation slices. Each logical aggregation slice is defined as a collection of levels across all hierarchies of a data warehouse schema. Each element of this collection of levels represents a specific level of a hierarchy within star schema 320 in FIG. 3B.

A logical aggregation slice can be visualized in FIG. 4A using a line through the levels in the four hierarchies. For example, line 450 traverses the following levels: Family 412, State 422, Fiscal Year 432, and Year 442. Line 452 traverses the following levels: Line 414, Region 420, Fiscal Year 432, and Year 442. Line 454 traverses the following levels: Line 414, State 422, Fiscal Year 432, and Year 442. Each of these lines represents a logical aggregation slice in this example. Since line 454 is below lines 450 and 452, queries issued against the aggregation sub-regions, represented by lines 450 and 452 could be derived from the aggregation slice represented by line 454.

FIG. 4B depicts an exemplary diagram of four logical aggregation slices, 460, 462, 464, and 466, that were constructed from the four hierarchies shown in FIG. 4A and star schema 320 in FIG. 3B. Additional combinations of levels from the hierarchies shown in FIG. 4A can be constructed to define additional slices from star schema 320 in FIG. 3B.

FIG. 4C depicts an exemplary diagram of an alternate representation of the logical aggregation slices shown in FIG. 4A. For instance, instead of using the level names to represent the logical aggregation slices (FIG. 4B), the level depth information may be used. For example, the highest levels in each hierarchy shown in FIG. 4A may be represented by level 0, and each lower level represented using an increasing number. In that case, the highest level, all product 410, all market 418, all time 430, and all time 440 are level 0, and the next level, family 412, region 420, fiscal year 432, and year 442 are level 1, and so on.

The logical aggregation slices 460, 462, 464, and 466 of FIG. 4B can then be alternatively represented by vectors 470, 472, 474, and 476, respectively of FIG. 4C. For example, vector 470 is a level depth representation of logical aggregation slice 460 in FIG. 4B.

FIG. 5A depicts a diagram of an exemplary query 500 issued against tables of a database, such as a data warehouse, using a predefined language, such as structured query language (SQL). In this example, query 500 is an aggregation query issued against star schema 320 in FIG. 3B.

Section 502 in query 500 in FIG. 5A depicts an additive measure. Measures describe data calculations from columns in a relational table. Additive measures are measures that can be derived from multiple intermediate aggregation levels. For example, sum( ), count( ), min( ), and max( ) are additive measures. A sum measure at a year level can be derived from the sum measure at a quarter level or the sum measure at a month level. Similarly, a count measure at a year level can be derived from the count measure at a quarter level or at a month level.

FIG. 5B depicts an exemplary diagram of logical aggregation slices 504, 506, 508 and 510. In this example, aggregation query 500 in FIG. 5A traverses a sub-region covered by the logical aggregation slice 504 of FIG. 5B.

Since section 502 in query 500 in FIG. 5A involves an additive measure, this query also is covered by logical aggregation slices located below it, namely, 506, 508, or 510 of FIG. 5B. A first logical aggregation slice is said to be below a second logical aggregation slice if the level depth values of the first logical aggregation slice are not less than the level depth values for the second logical aggregation slice.

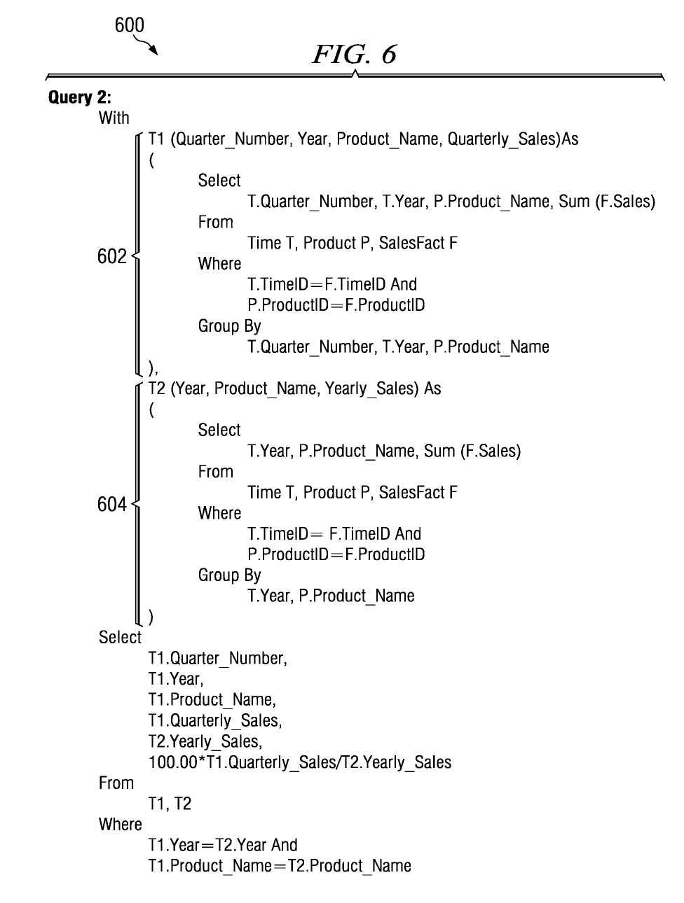

FIG. 6 depicts a diagram of an exemplary query issued against star schema 320 of FIG. 3B. Queries issued against a data warehouse schema may have one or more sub-queries, and those sub-queries may be aggregate sub-queries. For example, query 600 contains two aggregation sub-queries 602 and 604.

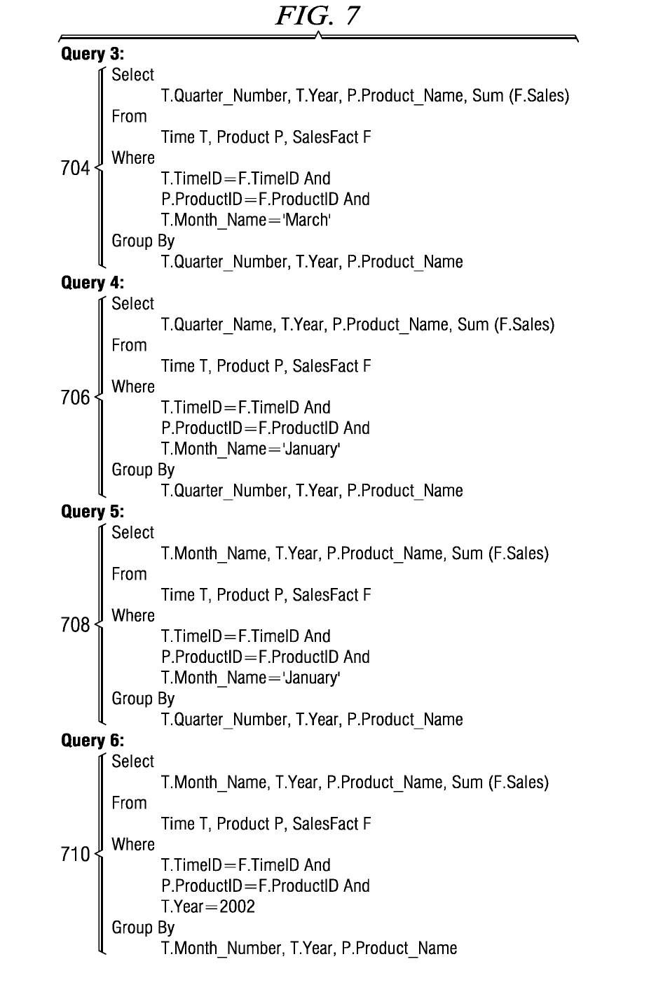

FIG. 7 depicts four exemplary aggregation queries, 704, 706, 708 and 710. Each of these aggregation queries 704, 706, 708, and 710, can be answered by the logical aggregation slice (product, all market, all time, month) of section 400 in FIG. 4A. Thus, a single aggregation slice in the data warehouse can answer multiple queries issued against a data warehouse schema.

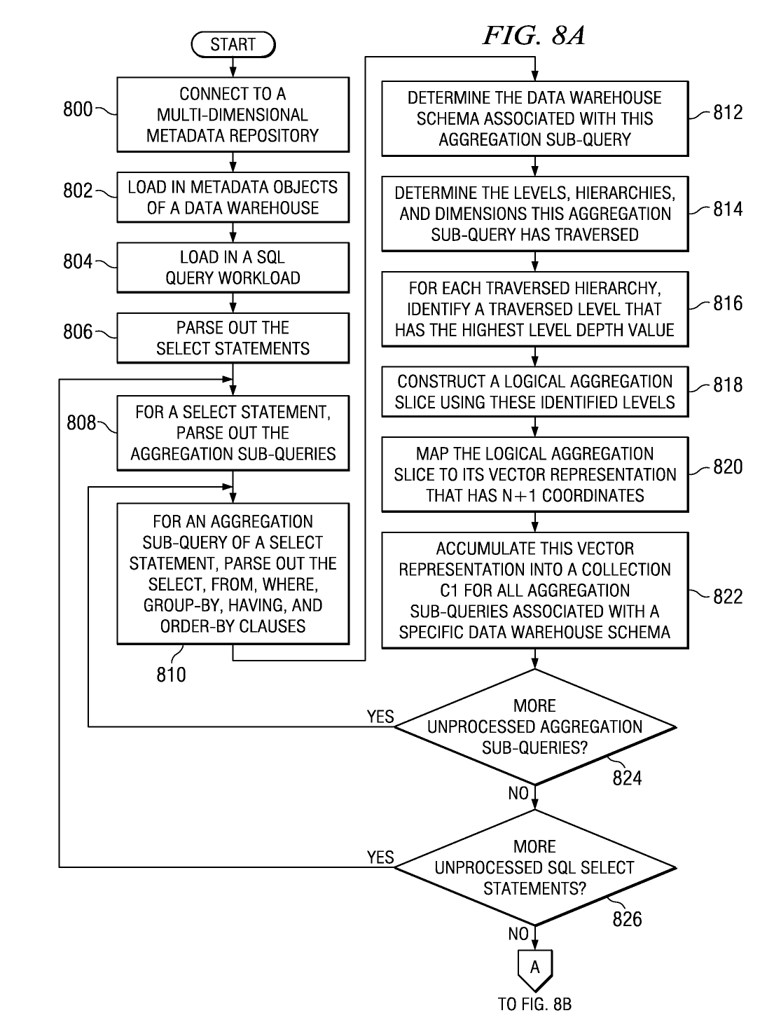

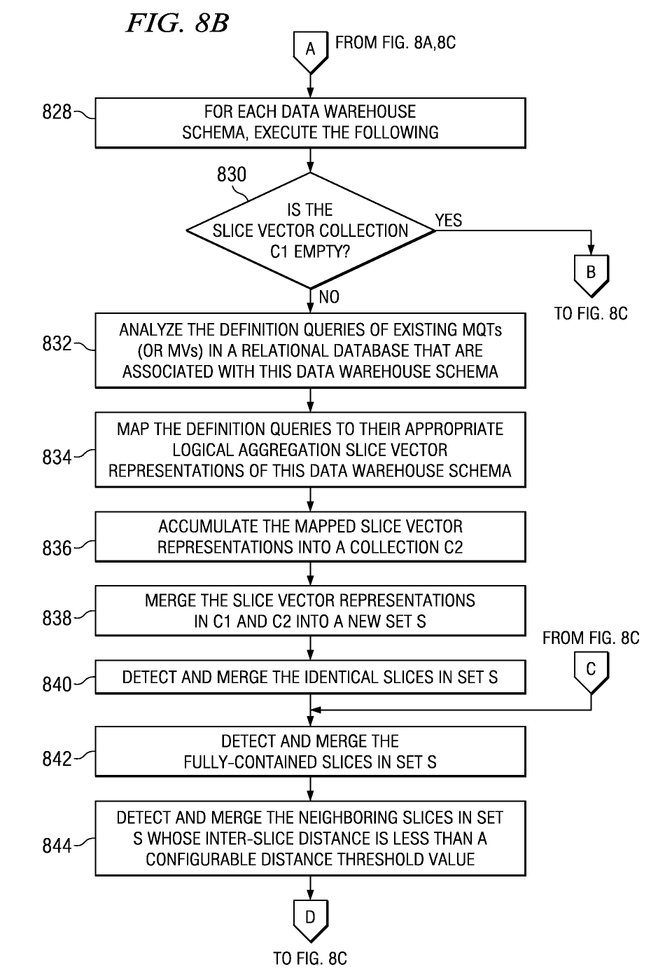

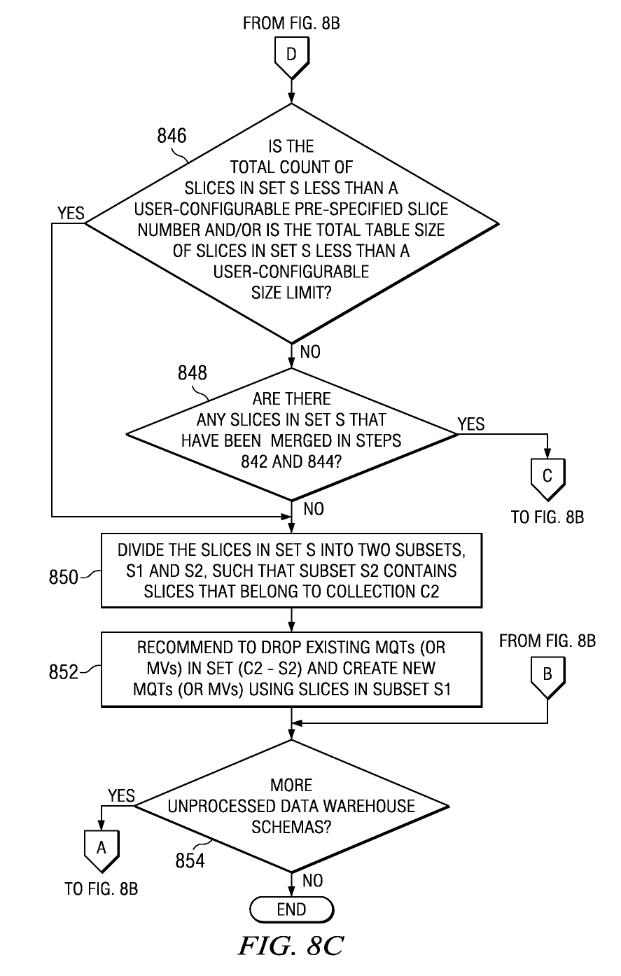

With reference next to FIGS. 8A-8C, a flowchart of a process for constructing, consolidating and recommending materialized query tables from metadata and query workload is depicted in accordance with an illustrative embodiment of the present invention. In these examples, the process illustrated in FIGS. 8A-8C may be implemented in a software component, such as, for example, control server 302 in FIG. 3A. In these examples, process encompasses construction, consolidation, and recommendation of new materialized query tables as well as the consolidation and the elimination of some existing materialized query tables.

The process begins by connecting to a multi-dimensional metadata repository (step 800). The repository may be stored outside of a database, inside a database next to a multi-dimensional data warehouse, such as the data warehouse 300 in FIG. 3A, or inside a dedicated metadata server. Next, metadata objects from the repository are loaded (step 802). These objects include, for example, cube models, dimensions, hierarchies, levels, facts, measures, filter, tables, and table joins.

A SQL query workload is then loaded (step 804). The query workload contains the queries that are executed against the database. The queries in the query workload are used to identify an initial set of candidate logical aggregation slices for each data warehouse schema as described in the step below.

Once the query workload is loaded, Select statements from the query workload are parsed out (step 806). These Select statements identify a set of one or more tables and a set of one or more columns in the set of tables for the query. Aggregation sub-queries are then parsed out of a Select statement (step 808). As shown in sections 602 and 604 in FIG. 6, a Select statement can have more than one aggregation sub-query.

Select, From, Where, Group-by, Having, and Order-by clauses are then parsed out of an aggregation sub-query (step 810).

Next, the data warehouse schema associated with the aggregate sub-query is determined (step 812). For example, the data warehouse schema may be determined by examining tables of the From clause, join predicates of the Where clause, and the cube models, facts, dimensions, tables, and table joins metadata information.

The levels, hierarchies, and dimensions traversed by the aggregate sub-query are determined (step 814). For each traversed hierarchy, the process identifies a traversed level that has the highest level depth value (step 816). For example, in section 400 in FIG. 4A, if an aggregate sub-query traversed both Region 420 at depth level 1, and City 424 at depth level 3, of the Market hierarchy 404, depth level 3 for City 424 is identified because this depth level is the highest depth value of the two depth levels of the same hierarchy traversed by the aggregate sub-query.

Next, a logical aggregation slice for the identified levels from step 816 is constructed (step 818). Since a data warehouse schema consists of a base data slice and all possible logical aggregation slices defined by all possible combination of levels, the logical aggregation slice constructed in step 818 is one of the many logical aggregation slices. In these examples, each aggregation sub-query is mapped to a particular candidate logical aggregation slice. Since multiple aggregation sub-queries of a given query workload can be mapped to a single candidate logical aggregation slice, a query hit count value can be maintained for each candidate logical aggregation slice. Furthermore, if a candidate logical aggregation slice is visited by a query that involves one or more non-additive measures, a special flag can be assigned to this logical aggregation slice such that this candidate slice will not be merged into other candidate slices covering different sub-regions of a data warehouse schema.

Thus, aggregation sub-queries of a given query workload can be used to help identify a subset of candidate logical aggregation slices.

Thereafter, the candidate logical aggregation slice identified in step 818 is mapped to a vector representation with N+1 coordinates (step 820) where N is the total number of hierarchies of a data warehouse schema. For example, a candidate logical aggregation slice shown in 466 of FIG. 4B is mapped to a vector shown in 476 of FIG. 4C. The vector representation is an example of a descriptor for a candidate logical aggregation slice.

The difference between vector representations of the logical aggregation slices in FIG. 4C and the vectors used in step 820 is that the vectors in step 820 have an extra coordinate value that represents the participation of measures of an aggregation sub-query. If the aggregation sub-query does not involve any measures, in the case of rolling up the dimension attributes to derive a sub-dimension data, this extra coordinate value will be set to zero. Otherwise, the coordinate value will be set to one. Thus, in this vector representation, the first coordinate stores an indicator value of the participation of measures inside the query. The remaining coordinates of the vector encode the level depth values identified in step 816.

The vector representation of this identified logical aggregation slice is then accumulated into a collection C1 for all aggregation sub-queries associated with the data warehouse schema (step 822). These vector representations form a set of descriptors for the slices. Collection C1 is a collection of vector representations of identified logical aggregation slices of a data warehouse schema visited by aggregation sub-queries of this given query workload.

Then, the presence of additional aggregation sub-queries that have not been processed is determined (step 824). If additional aggregation sub-queries are present the process returns to step 810 as described above. Steps 810-822 are repeated for each aggregation sub-query within the current Select statement of the query workload until all of the aggregation sub-queries have been processed.

Then, the presence of additional SQL Select statements in the given query workload that have not been processed is determined (step 826). If additional unprocessed SQL Select statements are present, the process returns to step 808 to choose another SQL Select statement for processing. Thus, steps 808-824 are repeated for each SQL Select statement of the original query workload.

When all of the SQL Select statements have been processed, an initial candidate slice set for each data warehouse schema is constructed. To that end, a data warehouse schema is selected to process its associated initial candidate set (step 828). A determination is made as to whether the collection of vectors C1 is empty (step 830). If the collection is not empty, the definition queries of existing materialized query tables (MQTs) or materialized views (MVs) in the database that are associated with the selected data warehouse schema are analyzed (step 832). The definition queries of the existing MQTs are then mapped to their appropriate multi-dimensional slice representations of the same data warehouse schema (step 834). Steps 808-826 may be used to map the definition queries representing materialized query tables to multi-dimensional slices. These multi-dimensional slices are often referred to as materialized aggregation slices.

Once vector representations of materialized aggregation slices are created for the materialized query tables, the process accumulates the mapped slice vector representations of the materialized aggregation slices into a collection C2 (step 836). The vector representations of the materialized aggregation slices in this collection C2 take the same form as those for collection C1 since they share the same set of metadata associated with this data warehouse schema.

As a result, two collections of vector representations of slices are present for the data warehouse schema. For example, collection C1 is formed when the query workload is used to identify logical aggregation slices, and collection C2 is formed when the existing materialized query tables or materialized views are used to identify materialized aggregation slices. These two collections of slices are the initial candidate slices, and can be analyzed to determine what new materialized query tables are to be generated and/or what existing materialized query tables are to be deleted.

Next, the vector slice representations in collections C1 and C2 are merged into a new vector set S (step 838). This set is a set of one or more slices, which may contain both logical and materialized aggregation slices.

Identical candidate slices in set S are detected and merged (step 840). When identical slices are merged, the hit counts for the queries traversing those slices are also merged. Step 840 is used to eliminate any identical logical aggregation slices that are already materialized or identical logical aggregation slices that are traversed by different aggregation sub-queries of a given query workload. Thus, only unique slices exist in set S after the merge.

Next, fully-contained slices in set S are detected and merged (step 842). In step 842, the collection of slices is analyzed for slices that may fully contain other slices present in the collection. A slice is said to be contained by another slice if the level depth values of level objects representing a slice are smaller than or equal to the corresponding level depth values of level objects representing another slice. For example, the line 450 in FIG. 4A represents a slice that is fully contained by another slice represented by line 454.

A geometric interpretation of this property is that when a higher level slice (with lower level depth values) is above or at a lower level slice (with higher level depth values), one can use the aggregate values defined at the lower level aggregation slice to answer queries issued against the region covered by the higher level aggregation slice. Therefore, in order to minimize the total number of materialized aggregation slices in a database, fully contained slices are detected and merged into the containing slices with one exception. That is if a fully contained slice has a special flag indicating that this candidate slice was visited by at least one aggregation sub-query involving one or more non-additive measures, the merging process will not take place so that this fully contained candidate slice remains in set S. When a slice is merged into another slice, the hit count value of this slice is merged into the hit count value of another slice.

The process then detects and merges neighboring candidate slices whose inter-slice distance is less than a user-configurable distance threshold value (step 844). Step 844 involves calculating the distance between remaining slices in set S. In these examples, a configurable distance threshold value is used. As a result, in step 844, any slices that are separated from each other by less than the distance threshold value are detected and merged, further reducing the number of remaining slices in set S. In this manner, steps 838 though 844 are used to consolidate slices in S, the set of candidate logical aggregation slices.

An example of slices that are not fully contained, but may be merged or consolidated is found in logical aggregation slices represented by lines 450 and 452 in FIG. 4A. These two lines intersect, signifying that neither of the slices fully contains the other slice. Since a lower level can be used to derive information at a higher level in a hierarchy, the slices represented by these two lines can be merged. In this illustrative example, a merger of these two slices results in a slice represented by line 454 in FIG. 4A. When slices are consolidated into a new slice, the hit counts for those slices are also merged and are associated with the new slice.

Further, a configurable maximum number of slices in the set S or a configurable total table size limit for slices in the collection S may be used. A determination is made as to whether the total count of slices in set S is less than a user-configurable pre-specified slice number or/and the total table size of slices in set S is less than a user-configurable size limit (step 846).

If the total count is not less than the pre-specified number and/or the total table size of slices is not less than a user-configurable limit, a determination is made as to whether any slices in set S have been merged in steps 842 and 844 (step 848). If the slices have been merged, step 842 is repeated because the slices resulting from the merger of fully contained slices and from the merger of neighboring slices may fully contain other slices. Steps 842-848 are repeated until the total number of slices in set S meets the pre-configured maximum number of slices, or the accumulated table sizes of slices in set S meets the total size limit, or there are no more slices that can be merged.

After the slices have been merged or consolidated as described above, slices may be recommended (step 850). The slices in set S are divided into subsets S1 and S2 such that subset S2 contains the materialized aggregation slices from collection C2 (step 850).

Existing materialized query tables or MVs in set (C2-S2) are recommended to be dropped. And new materialized query tables (or MVs) are recommended to be created using slices in subset S1 (step 852). The recommendation includes materialization of those absent materialized query tables and a possible deletion of one or more existing materialized query tables for those materialized but obsolete slices.

The recommendation in step 852 may be made in a number of different ways. For example, materialized aggregation slices in the database for logical aggregation slices in the first subset may be created in a descending order of hit count values associated with logical aggregation slices within a storage limit of the database. In this manner, limits on database space may be taken into account.

Thereafter, a determination is made as to whether more unprocessed data warehouse schemas are present (step 854). If additional unprocessed data warehouse schemas are present, another data warehouse schema is selected (step 828) for processing. Otherwise, the process terminates.

With reference again to step 830, if the slice vector collection C1 is empty, the process proceeds directly to step 854 and a determination is made as to whether more unprocessed data warehouse schemas are present as described above.

The recommendation technique illustrated in FIGS. 8A-8C may be applied, for example, by a user or software process periodically or in response to some event. By applying this process periodically over accumulated query workloads, new slices may be materialized and obsolete materialized slices may be dropped in a database to meet changing needs in the data warehouse.

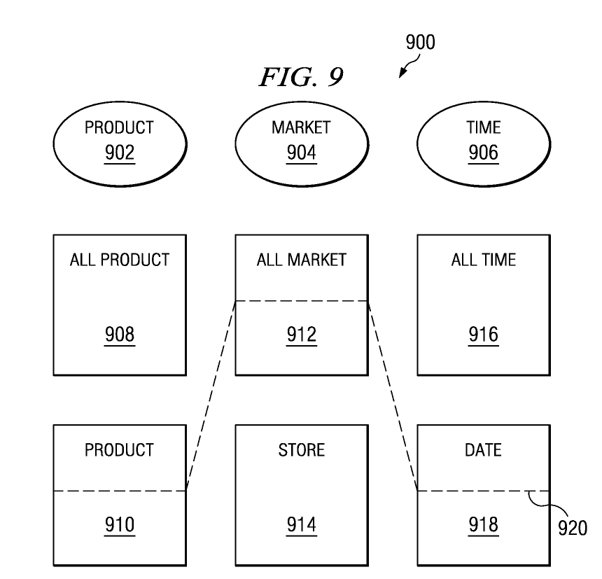

FIG. 9 is a diagram illustrating a simplified metadata model where multiple hierarchies and levels of a dimension are compressed into a single hierarchy that has two levels for each dimension. In this example, section 900 depicts a simplified data warehouse metadata model shown in FIGS. 3B and 4A where the original Product hierarchy shown by Product 402 in FIG. 4A is simplified into a new Product hierarchy in Product 902, the original Market hierarchy shown as Market 404 in FIG. 4A is simplified into a new Market hierarchy shown in Market 904, and original Fiscal and Calendar hierarchies shown in Fiscal 406 and Calendar 408 in FIG. 4A are simplified into a new Time hierarchy shown in 906. Product 902 includes All Product 908 and Product 910 as levels. Market 904 includes All Market 912 and Store 914 as levels. Time 906 includes All Time 916 and Date 918 as levels. Line 920 traversing Product 910, All Market 912, and Date 918 levels represents a sample candidate aggregation slice of this simplified data warehouse metadata model.

Nevertheless, the process described in FIGS. 8A-8C is still applicable to this simplified metadata model so long as each aggregation sub-query of a given query workload is mapped to a candidate aggregation slice in this simplified metadata model. As shown in this figure, the total number of candidate aggregation slices for this model is relatively small and each candidate aggregation slice will contain either a leaf level of a hierarchy or an all level of a hierarchy. Since a leaf level usually represents the base data of a hierarchy and an all level indicates an inclusion of all information from a hierarchy, a candidate aggregation slice in this simplified model really represents a fact table of a data mart whose dimension information is determined by the dimensions whose leaf levels are used to construct this aggregation slice. For example, line 920 represents an aggregation slice that was pinned down at the leaf levels of the Product and Time dimensions. Therefore, a materialized slice of this type of aggregation slice in a database (or in other data management systems) is equivalent to a fact table of a data mart that consists of Product and Time dimensions of the original data warehouse as describe above.

Thus, the aspects of the present invention provide a computer implemented method, apparatus, and computer usable program code for constructing, consolidating, and recommending new aggregation slices for materialization in a database. In these examples, candidate slices are logically constructed from descriptions defined by the multidimensional metadata of a data warehouse schema. Then this persistent candidate slice set is filtered by the aggregation sub-queries of a given query workload. Next, the remaining candidate slices are joined by the materialized slices in the database and are consolidated using the containment and neighboring relationships. Finally the remaining slices with the most hits are recommended for materialization. Further, the aspects of the present invention may also analyze and recommend the deletion of materialized slices that may be present in a database.

In this manner, the illustrative embodiments provide an ability to generate a set of materialized query tables using metadata and query workload to cover the frequently visited areas of a data warehouse schema. Further, the aspects of the present invention may be applied to databases for which metadata information and query workload information are available.

For example, the aspects of the present invention may be implemented in On-line Analytic Processing (OLAP) systems. The first kind is a relational OLAP system that uses the multi-dimensional information embedded in the data warehouse metadata to generate multi-phased SQL queries that often start with aggregation sub-queries going against the base data of a data warehouse in a relational database.

The second kind is a multi-dimensional OLAP system that maps a data warehouse model described by its multi-dimensional metadata into a multi-dimensional cube structure outside of a relational database and builds up the aggregate values of this multi-dimensional cube structure on-demand by issuing aggregation sub-queries against the base data of a data warehouse in a relational database. In both cases, the historical aggregation sub-query information and the data warehouse metadata information can be used to recommend some pre-computed aggregate tables to help speed up either a multi-phased SQL query that starts with some relational aggregation sub-queries or an OLAP query that starts with generating some new aggregate values of a multi-dimensional cube.

For another example, the aspects of the present invention may be implemented in an enterprise data warehouse system to help speed up queries that are concentrated in specific sub-regions of the data warehouse. As shown in FIG. 9, a user can use a simplified metadata model and a query workload associated with this enterprise data warehouse to recommend materialized aggregation slices whose definition queries are identical to queries one would use to define and create fact tables of data marts, physical subsets of a data warehouse. Then, with the materialized query table approach, an application does not have to maintain a separate data entity such as a data mart and does not have to tie its implementation to the physical structure of a data mart. Instead, the application just issues queries against the base data of an enterprise data warehouse. The relational database engine will transparently reroute an incoming query issued against the base data but requesting some aggregate data to some materialized query tables or materialized views that are functionally equivalent to fact tables of data marts.

Although these examples are directed towards the generation of materialized query tables, these examples are not meant as limitations on the types of data that can be generated from or stored into the aggregation slices. The aspects of the present invention may be applied to any pre-computed aggregate data that is derived from the base data of a data warehouse schema stored in a database or a data storage facility.

Further, the aspects of the present invention may be applied to other types or constructs of aggregate data other than slices. A slice as used in the examples is a specific form of a set of aggregation data. A logical aggregation slice is a logical set of aggregation data. The aspects of the present invention may be applied to other types of sets of aggregation data. An example is a sub-slice, which is a subdivision of elements of levels participating a slice into subsets of elements and including one of the subsets of elements of a level to represent the participation of a hierarchy to this slice. Subsets of elements of a level are also referred to as buckets. Therefore, a sub-slice is a combination of one level or one bucket of a level of each hierarchy of a data warehouse schema. Thus, the aspects of the present invention may operate on sets of logical aggregation data to identifying a plurality of logical sets of aggregation data within a database, wherein the plurality of logical sets of aggregation data are described by metadata for the database; select a number of logical sets of aggregation data from the plurality of logical sets of aggregation data based on a policy to form a selected number of logical sets of aggregation data; and recommend a materialization of the aggregation data using the selected number of logical sets of aggregation data.

Specifically, this process may also be applied to data warehouse systems in which query reroute technologies, such as materialized query tables, are not available. The process for this may be as follows:
1. Import the metadata from the metadata repository;
2. Get the cube model, dimensions, hierarchies, levels, facts, measures, filters, tables, and table joins information for each data warehouse schema that describe logical aggregation slices of a data warehouse schema;
3. Import a given query workload, parse out the aggregation sub-queries, and identify a subset (C1) of logical aggregation slices of a data warehouse schema traversed by aggregation sub-queries of this given query workload;
4. Go to the metadata repository to find out all aggregation slices that are created in the database already and accumulate these materialized aggregation slice information into set C2;
5. Merge set C1 with set C2 to create set S;
6. Detect and merge the identical slices in set S and update the hit count value accordingly;
7. Detect and merge the fully-contained slices in set S and update the hit count value accordingly;
8. Detect and merge the neighboring slices in set S and update the hit count value accordingly;
9. Repeat steps 7 and 8 until certain conditions are satisfied;
10. Divide the final set S into set S1 and set S2 where set S2 contains a subset of the materialized aggregation slices in C2;
11. Recommend to Drop Materialized Aggregate tables, whose slice representations are in set (C2-S2);
12. Recommend to create new aggregate tables whose slice representations are in set S1; and
13. If a user does drop or create these recommended aggregate tables in the database, update the materialized aggregation slice information stored in the metadata repository.

An application's query generator will go to the same metadata repository to obtain the materialized aggregation slice information and generate query statements that take full advantage of these materialized aggregate tables in the database before it sends the efficient query statements to the database. In practice, a user can store this materialized aggregation slice information in any place they want. The difference between this approach and the materialized query table (MQT/MV) approach is that a user needs to manage and utilize the materialized aggregation slices in a database as well as the materialized aggregation slice information stored in a repository by themselves.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating data for a database, the computer implemented method comprising:
identifying a plurality of logical sets of aggregation data within a database, wherein the plurality of logical sets of aggregation data are described by metadata for the database;
selecting a number of logical sets of aggregation data from the plurality of logical sets of aggregation data based on a policy to form a selected number of logical sets of aggregation data; and
recommending a materialization of the aggregation data using the selected number of logical sets of aggregation data.

2. The computer implemented method of claim 1, wherein the selecting step comprises:
selecting the number of logical sets of aggregation data from the plurality of logical sets of aggregation data based on the policy; and
consolidating the number of logical sets of aggregation data based on relationships between different logical sets of aggregation data in the number of logical sets of aggregation data to form selected number of logical sets of aggregation data.

3. The computer implemented method of claim 2 further comprising:
constructing a collection of descriptors to describe the selected number of logical sets of aggregation data, wherein the number of selected logical sets of aggregation data are consolidated using the descriptors.

4. The computer implemented method of claim 2, wherein selecting the number of logical sets of aggregation data from the plurality of logical sets of aggregation data based on the policy comprises:
using the metadata to map aggregation sub-queries traversing the database to respective logical sets of aggregation data associated with the aggregation sub-queries and described by the metadata to form a first collection of selected logical sets of aggregation data;
using the metadata to map definition queries associated with materialized aggregation data in the database to respective logical sets of aggregation data associated with the definition queries and described by the metadata to form a second collection of selected logical sets of aggregation data; and
merging the first collection and the second collection to form a candidate logical set of aggregation data.

5. The computer implemented method of claim 4, wherein the consolidating step comprises:
merging identical logical sets of aggregation data in the candidate logical set of aggregation data;
merging fully contained logical sets of aggregation data in the candidate logical set of aggregation data;
merging neighboring logical sets of aggregation data in the candidate logical set of aggregation data;
accumulating and updating hit count values for merged logical sets of aggregation data in the candidate logical set of aggregation data; and
repeating the merging steps and the accumulating step until a selecting condition is met to form a final candidate logical set of aggregation data.

6. The computer implemented method of claim 5, wherein the recommending step comprises:
dividing the final candidate logical set of aggregation data into a first subset and a second subset, wherein the second subset contains a subset of materialized aggregation data in the database from the second collection;
recommending dropping existing materialized aggregation data from a database whose logical sets of aggregation data representations are not in the second subset; and
recommending creating materialized aggregation data sets in the database for logical sets of aggregation data in the first subset.

7. The computer implemented method of claim 6, wherein the step of recommending creating materialized aggregation data sets in the database for the logical sets of aggregation data in the first subset is executed in a descending order of hit count values associated with the logical sets of aggregation data within a storage limit of the database.

8. The computer implemented method of claim 1, wherein the database is a data warehouse.

9. The computer implemented method of claim 1, wherein the logical sets of aggregation data are logical aggregation slices.

10. The computer implemented method of claim 1, wherein the logical sets of aggregation data are logical aggregation sub-slices.

11. The computer implemented method of claim 1, wherein the logical sets of aggregation data described by the metadata remain unchanged when the computer implemented method is executed multiple times.

12. A computer program product comprising:
a computer usable medium having computer usable program code for generating data for a database, the computer program medium comprising:
computer usable program code for identifying a plurality of logical sets of aggregation data within a database, wherein the plurality of logical sets of aggregation data are described by metadata for the database;
computer usable program code for selecting a number of logical sets of aggregation data from the plurality of logical sets of aggregation data based on a policy to form a selected number of logical sets of aggregation data; and
computer usable program code for recommending a materialization of the aggregation data using the selected number of logical sets of aggregation data.

13. The computer program product of claim 12, wherein the computer usable program code for selecting step comprises:
computer usable program code for selecting the number of logical sets of aggregation data from the plurality of logical sets of aggregation data based on the policy; and
computer usable program code for consolidating the number of logical sets of aggregation data based on relationships between different logical sets of aggregation data in the number of logical sets of aggregation data to form selected number of logical sets of aggregation data.

14. The computer program product of claim 13 further comprising:
computer usable program code for constructing a collection of descriptors to describe the selected number of logical sets of aggregation data, wherein the number of selected logical sets of aggregation data are consolidated using the descriptors.

15. The computer program product of claim 13, wherein the computer usable program code for selecting the number of logical sets of aggregation data from the plurality of logical sets of aggregation data based on the policy comprises:
computer usable program code for using the metadata to map aggregation sub-queries traversing the database to respective logical sets of aggregation data associated with the aggregation sub-queries and described by the metadata to form a first collection of selected logical sets of aggregation data;
computer usable program code for using the metadata to map definition queries associated with materialized aggregation data in the database to respective logical sets of aggregation data associated with the definition queries and described by the metadata to form a second collection of selected logical sets of aggregation data; and
computer usable program code for merging the first collection and the second collection to form a candidate logical set of aggregation data.

16. The computer program product of claim 15, wherein the computer usable program code for consolidating the number of logical sets of aggregation data based on relationships between different logical sets of aggregation data in the number of logical sets of aggregation data to form selected number of logical sets of aggregation data comprises:
computer usable program code for merging identical logical sets of aggregation data in the candidate logical set of aggregation data;
computer usable program code for merging fully contained logical sets of aggregation data in the candidate logical set of aggregation data;
computer usable program code for merging neighboring logical sets of aggregation data in the candidate logical set of aggregation data;
computer usable program code for accumulating and updating hit count values for merged logical sets of aggregation data in the candidate logical set of aggregation data; and
computer usable program code for repeating the merging steps and the accumulating step until a selecting condition is met to form a final candidate logical set of aggregation data.

17. The computer program product of claim 16, wherein the computer usable program code for recommending a materialization of the aggregation data using the selected number of logical sets of aggregation data comprises:
computer usable program code for dividing the final candidate logical set of aggregation data into a first subset and a second subset, wherein the second subset contains a subset of materialized aggregation data in the database from the second collection;
computer usable program code for recommending dropping existing materialized aggregation data from a database whose logical sets of aggregation data representations are not in the second subset; and
computer usable program code for recommending creating materialized aggregation data sets in the database for logical sets of aggregation data in the first subset.

18. The computer program product of claim 17, wherein the computer usable program code for recommending creating materialized aggregation data sets in the database for the logical sets of aggregation data in the first subset is executed in a descending order of hit count values associated with the logical sets of aggregation data within a storage limit of the database.

19. The computer program product of claim 12, wherein the database is a data warehouse.

20. The computer program product of claim 12, wherein the logical sets of aggregation data are logical aggregation slices.

21. The computer program product of claim 12, wherein the logical sets of aggregation data are logical aggregation sub-slices.

22. The computer program product of claim 12, wherein the logical sets of aggregation data described by the metadata remain unchanged when the computer usable program code executed multiple times.

23. A data processing system comprising:
a bus;
a communications unit connected to the bus;
a memory connected to the bus, wherein the storage device includes computer usable program code; and
a processor unit connected to the bus, wherein the processor unit executes the computer usable program code to identify a plurality of logical sets of aggregation data within a database, wherein the plurality of logical sets of aggregation data are described by metadata for the database; select a number of logical sets of aggregation data from the plurality of logical sets of aggregation data based on a policy to form a selected number of logical sets of aggregation data; and recommend a materialization of the aggregation data using the selected number of logical sets of aggregation data.
